(19) United States
(12) Patent Application Publication
(10) Pub. No.: US 2026/0179474 A1
(43) Pub. Date: Jun. 25, 2026

(54) FIRE LOOP EXTENDER MODULE

(71) Applicant: Honeywell International Inc., Charlotte, NC (US)

(72) Inventors: Manoj Thankappan Nair, Bengaluru (IN); Sudeep Jayakumar Duge, Bengaluru (IN); Sameer Tripathi, Bengaluru (IN)

(21) Appl. No.: 18/989,458

(22) Filed: Dec. 20, 2024

(51) Int. Cl. G08B 29/04

(52) U.S. Cl. CPC G08B 29/043

(57) ABSTRACT

Devices, methods, and systems for extending a fire loop are described herein. An example device for a fire alarm system includes a first communication pathway coupled to a first plurality of fire sensing devices wired in a first loop, a second communication pathway coupled to a second plurality of fire sensing devices wired in a second loop, wherein the second loop is independent of the first loop, and a controller configured to drive the second plurality of fire sensing devices of the second loop and drive the first plurality of fire sensing devices of the first loop during a failure event occurring on the first loop.

### TECHNICAL FIELD

The present disclosure relates generally to devices, methods, and systems for extending a fire loop.

### BACKGROUND

Large facilities (e.g., buildings), such as commercial facilities, office buildings, hospitals, apartment complexes, manufacturing plants, large warehouses, airport terminals, train stations, and the like, may have a fire alarm system that can be triggered during an emergency event (e.g., a fire) to provide guidance to occupants of the facility, such as, for instance, a warning for the occupants to evacuate or control operations like door releases, lift operations, and mitigation operations (e.g., fire extinguishing and smoke control). For example, a fire alarm system may include a fire control panel and a plurality of fire sensing devices (e.g., sounders and/or smoke detectors), located throughout the facility (e.g., on different floors and/or in different rooms of the facility) that can sense a fire occurring in the facility and provide an audio notification of the fire to the occupants of the facility via alarms. The fire sensing devices may be wired in a loop formation in communication with the fire control panel to relay that an emergency event has been detected.

The fire control panel may have a fixed point capacity for the quantity of fire alarm devices it is able to support. Oftentimes, in large facilities, multiple fire control panels must be installed to support the extensive fire alarm system needed for the facility to comply with safety requirements. For instance, a fire control panel may need to be installed on each floor of a multi-level facility, or more than one fire control panel may need to be installed on a single floor of a large facility to accommodate the large number of fire sensing devices needed. There are major cost concerns with installing multiple control panels and additional wiring. Further, when a control panel is experiencing a failure, the fire alarm system may be interrupted which introduces major risk to the occupants of the facility.

### BRIEF DESCRIPTION OF THE DRAWINGS

FIG. 1 illustrates an example of a system including a fire loop extender module in accordance with an embodiment of the present disclosure.

FIG. 2 illustrates an example of a system including a fire loop extender module in accordance with an embodiment of the present disclosure.

FIG. 3 illustrates an example of a system including a fire loop extender module in accordance with an embodiment of the present disclosure.

FIG. 4 illustrates a flow diagram of a method for extending a fire loop in accordance with an embodiment of the present disclosure.

### DETAILED DESCRIPTION

Devices, methods, and systems for extending a fire loop are described herein. An example device for a fire alarm system includes a first communication pathway coupled to a first plurality of fire sensing devices wired in a first loop, a second communication pathway coupled to a second plurality of fire sensing devices wired in a second loop, wherein the second loop is independent of the first loop, and a controller configured to drive the second plurality of fire sensing devices of the second loop and drive the first plurality of fire sensing devices of the first loop during a failure event occurring on the first loop.

As noted above, previous approaches for expanding a fire alarm system in a large facility are a hugely cost-intensive process. For example, previous approaches for such fire alarm system expansion may require additional control panels to be installed at various points throughout a facility.

In contrast, embodiments of the present disclosure relate to safe, low cost approaches for extending a fire loop connected to a fire loop module, increasing a fire loop length, and providing redundant operation and local activation during failure. Fire safety systems for high-rise buildings, densely populated areas, or regions with high growth rates typically require the installation of new control panels and additional fire loop wiring, which can pose several cost concerns.

Embodiments of the present disclosure can extend an existing fire loop from the panel loop module to increase the capacity of fire loop devices as well as increase the length of the fire loop. Embodiments of the present disclosure can also provide redundant fire loop operation during panel loop failures that can perform fire loop detections, fire and fault reporting to the control panel, and local activation based on certain configurations. Embodiments of the present disclosure can also leverage the capability of a loop booster to boost the loop signal on the extended loop section, as well as limiting the current on the extended loop, which is suitable for Intrinsic Safe Environment and explosive atmosphere (e.g., ATEX) usages.

Further, as noted above, previous approaches may include installing additional fire alarm control panels within a facility to support additional fire sensing devices needed for safety compliance of a fire system in a large building, which is a costly solution that can introduce interruptions to the overall performance of a fire system. Also, integrating additional fire alarm control panels introduces additional resources that need to be monitored by fire maintenance specialists. However, extending an existing fire loop in accordance with the present disclosure can allow for a single integrated system at a lower cost that is easier to manage. For example, in some instances, extending an existing fire loop in accordance with the present disclosure can double the amount of addressable devices supported by the fire loop than previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

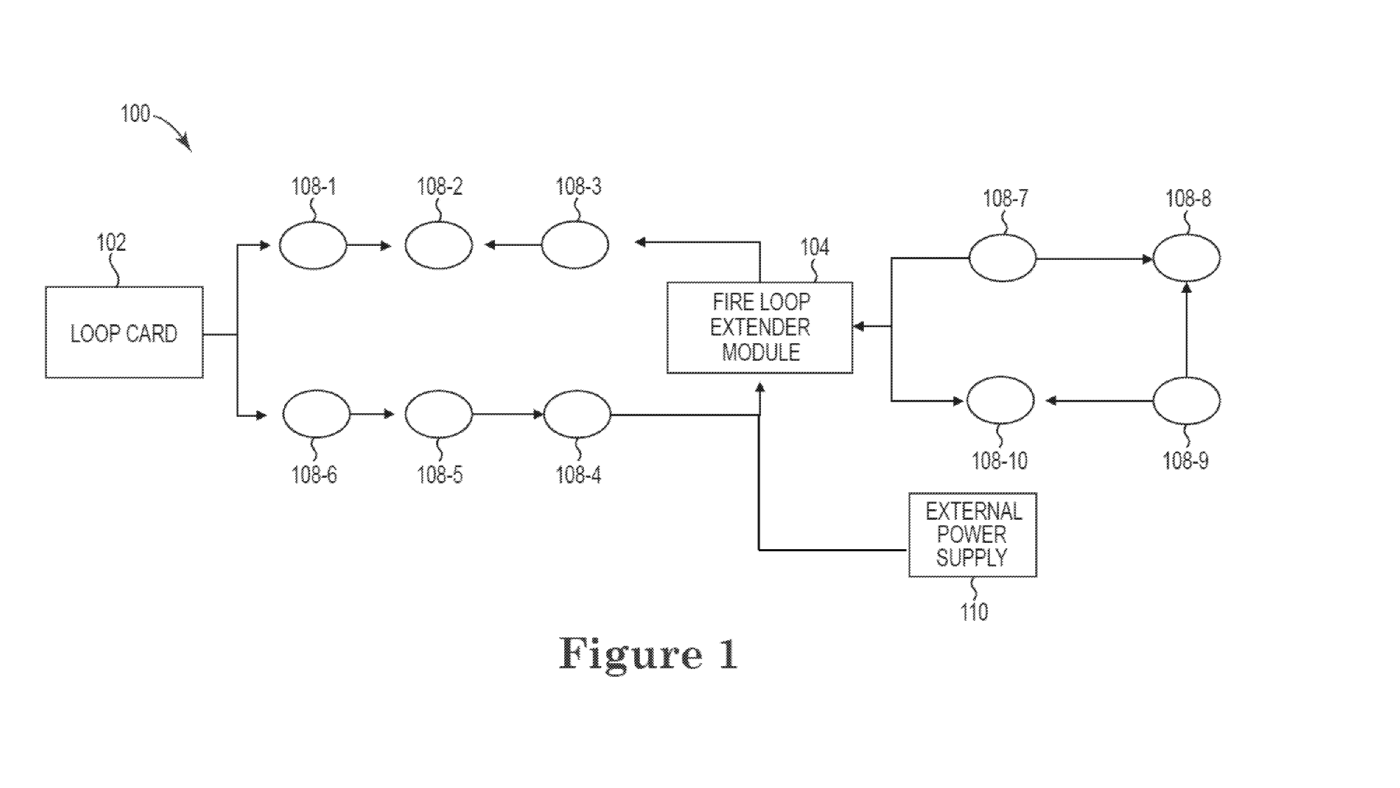

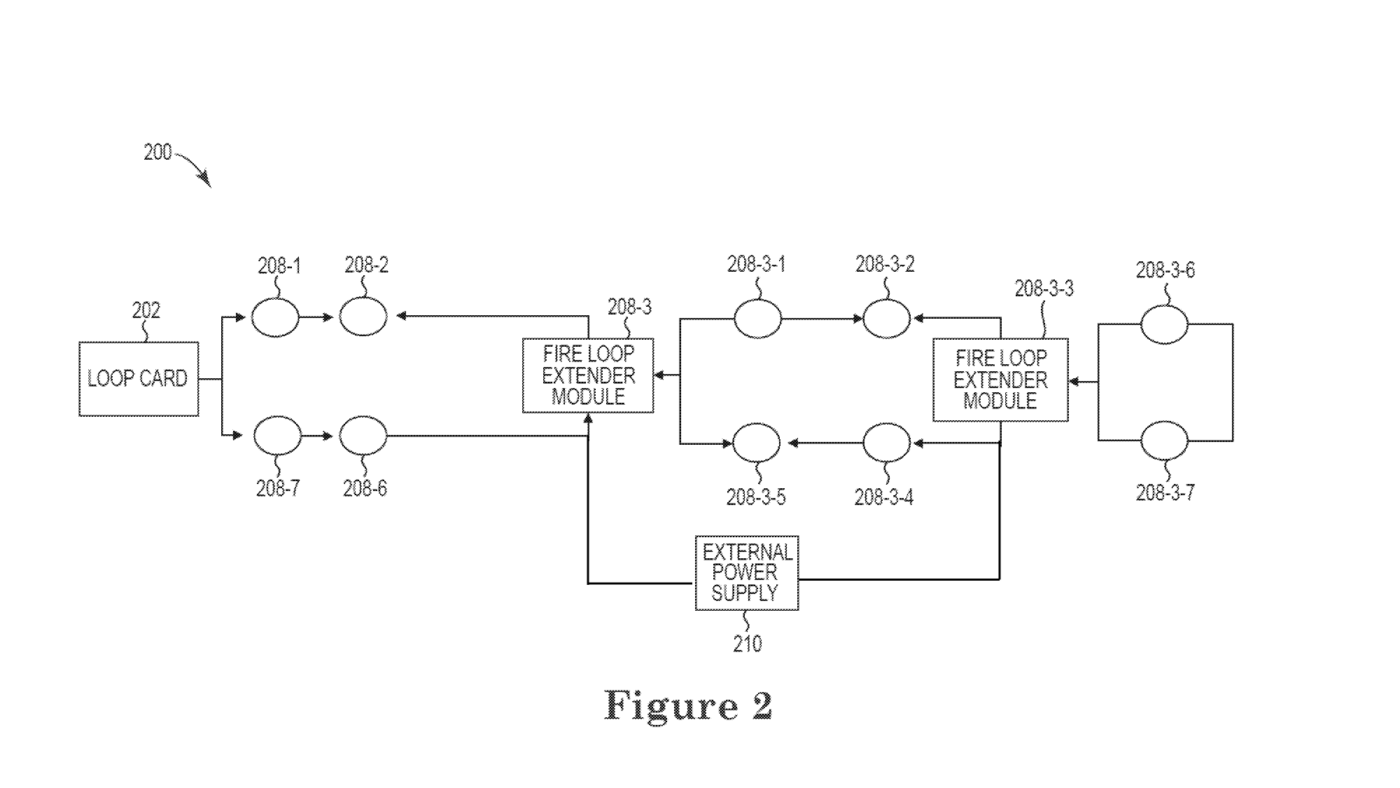

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 204 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 illustrates an example of a system including a fire loop extender module in accordance with an embodiment of the present disclosure. For example, a fire loop extender module 104 can be used to extend a fire loop within a fire alarm system 100. The fire alarm system 100 can include a loop card 102 coupled to a plurality of fire sensing devices 108-1, 108-2, 108-3, 108-4, 108-5, 108-6, which can collectively be referred to as fire sensing devices 108.

The fire sensing devices 108 may be wired in a loop formation (e.g., a configuration in which multiple devices are wired together in a sequence or ring), which may be referred to as a fire loop. The fire loop is not limited to a particular number of fire sensing devices and more or fewer devices may be included within the fire loop. The fire sensing devices 108 may be smoke detectors, heat sensors, or alarm sounders, for example.

The loop card 102 may be included within a fire alarm control panel. The fire alarm control panel may be physically installed within a facility as part of the fire alarm system. For instance, a user can use the control panel to directly control the operation of (e.g., actions performed by) the plurality of fire sensing devices 108 within the fire loop. Further, the control panel can receive (e.g., collect) data, such as, for instance, real-time operational data, from the fire sensing devices 108 via the loop card 102. Such data can include, for instance, current operational statuses, operational states, and/or properties of the fire sensing devices 108. As an additional example, the control panel can receive signals (e.g., alarm signals) from the fire sensing devices 108 indicating that an emergency event (e.g., a fire) is occurring in the facility. The fire sensing devices being monitored and/or controlled by the loop card 102 can include, in addition to devices such fire sensing device 108-1, fans and/or dampers that can perform smoke control operations (e.g., pressurizing, purging, exhausting, etc.) during a fire, and/or sprinklers that can provide water to extinguish a fire, among other components of the fire alarm system 100.

The loop card 102 (e.g., fire loop card) may serve as an interface for connecting and/or managing the fire sensing devices installed within a building. The loop card 102 may monitor the fire sensing devices for alarms (e.g., fire or smoke detections), faults (e.g., open or short circuits), or other events and may communicate the status of the fire sensing devices to the fire alarm control panel. The loop card 102 may also help identify each fire sensing device within a fire loop by its unique address for precise detection within addressable fire alarm systems.

In addressable fire alarm systems, unique digital addresses are assigned to each device within the system. For example, each fire sensing device 108-1, 108-2, 108-3, …, 108-6 may be assigned a unique digital address such that the system can pinpoint an exact location of an alarm or fault. Further, each fire sensing device may be programmed and monitored individually, which allows for customization and adaptation within the fire alarm system.

As described previously, the fire sensing devices 108 may be wired in a loop configuration. This arrangement allows for redundancy within the fire alarm system such that if one part of the loop is damaged, communication can continue in the opposite direction. For example, during normal operation of the fire system 100, the loop card 102 may power fire sensing devices 108-1, 108-2, and 108-3 in sequence. However, if fire sensing device 108-2 is damaged or experiencing a fault, fire sensing device 108-1 can continue communicating with loop card 102 in the opposite direction, and fire sensing device 108-3 can continue communicating with loop card 102 via fire sensing devices 108-4, 108-5, and 108-6.

As illustrated in FIG. 1, loop card 102 can power fire sensing devices 108-1 and 108-6 such that the loop is driven on both sides. The loop configuration illustrated in FIG. 1 is purely exemplary, and other configurations (e.g., loop direction, device placement) are possible. In previous approaches, fire sensing devices 108-3 and 108-4 would be wired in sequence to complete the fire loop and limit the loop card to a particular number of fire sensing devices. However, as described herein, a fire loop extender module 104 may be installed within the fire system 100 to extend the fire loop.

A fire loop extender module may be a device or apparatus configured to extend an existing fire loop. FIG. 1 illustrates fire loop extender module 104 in sequence with fire sensing device 108-3 and fire sensing device 108-4. However, other configurations are possible, and embodiments are not limited to a particular order or sequence. The fire loop extender module may be configured to extend the fire loop from the loop card 102 to increase the fire sensing device capacity of the existing loop, as well as increase the overall length of the fire loop. The fire loop extender module 104 may be configured to extend the existing fire loop to support more addressable fire sensing devices using sub-addresses or channels addressing from the loop extender module. Further, the fire loop extender module 104 may be configured to provide redundant fire loop operation during a loop card and/or control panel failure such that the fire loop extender module can perform fire loop detections, fault reporting, and local activation, among other functionalities.

The fire loop extender module 104 may also memory map each supported device of the fire loop extender module (e.g., fire sensing devices 108) and provide this to the loop card 102 so that the loop card 102 may read and operate each device independently. Further, the fire loop extender module 104 can be instructed by the loop card 102 to provide state and status information of the supported devices (e.g., fire sensing devices 108) and operate on these devices in a specific manner according to the instruction of the loop card 102.

The fire loop extender module 104 may be located at a suitable position away from the control panel. For example, the fire loop extender module 104 may be positioned within a facility in a similar manner as the fire sensing devices 108 wired in the fire loop. The fire loop extender module 104 may be recognized by the loop card 102 of the control panel as another complex device (e.g., a fire sensing device, module) that can extend the fire loop and provide additional functionalities within the fire loop and/or fire alarm system 100.

As an example, fire loop extender module 104 may be placed within the fire loop (e.g., between fire sensing device 108-3 and fire sensing device 108-4 as illustrated) such that the fire loop extender module 104 may function as an additional fire sensing device within the loop and drive the loop in sequence without interruption. For example, the fire loop may be operated in sequence such that the fire loop is driven from fire sensing device 108-4 to fire loop extender module 104 and then to fire sensing device 108-3, as illustrated in FIG. 1. Alternatively, the fire loop may be driven in the opposite direction such that the fire loop is driven from fire sensing device 108-3 to fire loop extender module 104 and then to fire sensing device 108-4 without interruption.

In another embodiment, the fire loop extender module 104 may function as an additional loop card and power the loop in both directions such that the first half of the loop is driven in sequence from fire sensing device 108-4 to fire sensing device 108-6 and the second half of the loop is driven in sequence from fire sensing device 108-3 to fire sensing device 108-1. Embodiments are not limited to a particular sequence or order, and alternative configurations are possible.

The fire loop extender module 104 may be located within the facility that includes the fire alarm system 100. The fire loop extender module may be separate from the loop card 102 and may be located external to the fire control panel. The fire loop extender module 104 may be located on the same floor of the facility as the fire loop or may be located on a different floor of the facility. Additionally, the fire loop extender module 104 may be physically located within the loop configuration, but may also be located external to the fire loop and communicate indirectly with the fire loop. For example, the fire loop extender module is not limited to a particular location or proximity to the fire loop and/or loop card 102.

As described previously, the fire loop extender module 104 may be configured to extend the existing fire loop to support more addressable devices within the fire system 100. Typically, the loop card 102 is limited to a particular number of addressable devices it is able to support (e.g., 159 addressable devices). However, the fire loop extender module 104 can be configured to extend the existing fire loop by supporting additional devices through sub-addresses or channels addressing from the fire loop extender module 104. For example, the loop card 102 may support 159 devices and the fire loop extender module may support an additional 159 devices such that the fire loop is extended to double the size of the original fire loop.

Fire loop extender module 104 may include multiple channels for each connected fire system device on the fire loop extender module 104 and one address for the fire loop extender module itself for fire safety protocols such as Contain, Leave, Inform, Protect (CLIP) and Flashcan. The fire loop extender module 104 can provide an additional fire loop length in this instance by functioning as a loop booster. Less current variants may be created to support ATEX requirements for portions of the loop. The fire loop protocol connected to the panel loop module (e.g., loop card 102) to be used can be configured accordingly, but the protocol downstream for the extended loop and devices connected to the fire loop extender module can utilize different protocols, such as advanced protocol, enhanced addressing, and/or additional Fieldbus protocol to provide additional capabilities. The fire loop extender module 104 can provide additional reporting, control, and configuration capabilities to the panel loop module (e.g., loop card 102).

Further, the fire loop extender module 104 can operate as a loop booster to boost the power supplied by the loop card 102 to fire sensing devices located further away from the loop card 102. For example, the fire loop extender module 104 can boost the power supplied by loop card 102 to reach fire sensing device 108-9, which is located furthest from loop card 102 in the example illustrated in FIG. 1. Fire sensing devices 108-7, …, 108-10 may be considered to be in an extended fieldbus loop (e.g., communication and power circuit that connects fire sensing devices to central control panel) but within a same address range as fire sensing devices 108-1, …, 108-6. However, in some embodiments, fire sensing devices 108-7, …, 108-10 may be in a separate address range from fire sensing devices 108-1, …, 108-6.

The additional devices supported by the fire loop extender module may be the same type of fire sensing device included in the original fire loop or may be a different type of fire sensing device. For example, as illustrated in FIG. 1, fire sensing devices 108-1, 108-2, …, 108-6 may be a first type of fire sensing device and fire sensing devices 108-7, 108-8, 108-9, and 108-10 supported by the fire loop extender module may also be of a first type of fire sensing devices. Alternatively, fire sensing devices 108-7, 108-8, …, 108-10 may be of a second type of fire sensing device. As an example, a first type of fire sensing device may be a sprinkler device, and a second type of fire sensing device may be an alarm device.

The additional fire sensing devices 108-7, 108-8, …, 108-10 supported by the fire loop extender module 104 may be in a loop configuration, similar to the first loop (e.g., fire sensing devices 108-1, …, 108-6), but may be operated independently from the first loop. For example, fire sensing devices 108-7, …, 108-10 may be driven separately from fire sensing devices 108-1, …, 108-6. As an alternative example, fire sensing devices 108-7, …, 108-10 may be driven in sequence with fire sensing devices 108-1, …, 108-6.

Embodiments of the present disclosure can further comprise a loop extender module powered by an externally monitored power supply to power the operation of additional fire system devices within the loop. Power provided by the loop module itself can service the fire loop but limit the power consumption of the fire system devices on the extended loop.

For example, the fire loop extender module 104 may be powered by an external power supply 110 that is separate from the control panel that includes 102. The external power supply 110 may be located within the facility that houses the fire alarm system 100 but may be located outside of the fire loop (e.g., not in sequence with fire sensing devices 108).

FIG. 2 illustrates an example of a system including a fire loop extender module in accordance with an embodiment of the present disclosure. Fire system 200 may illustrate a different configuration of fire system 100, as described in connection with FIG. 1. A fire loop extender module can be used to extend a fire loop within the fire system 200. The fire alarm system 200 can include a loop card 202 coupled to a plurality of fire sensing devices 208-1, 208-2, 208-6, 208-7, which may be collectively referred to as fire sensing devices 208.

Fire sensing devices 208 may be wired in a loop formation, which may be referred to as a fire loop. The fire loop is not limited to a particular number of fire sensing devices and more or fewer devices may be included within the fire loop. The fire sensing devices 208 may be smoke detectors, heat sensors, or alarm sounders, for example.

The loop card 202 (e.g., fire loop card) may serve as an interface for connecting and/or managing the fire sensing devices 208 installed within a building. The loop card 202 may monitor the fire sensing devices 208 for alarms (e.g., fire or smoke detections), faults (e.g., open or short circuits), or other events and may communicate the status of the fire sensing devices 208 to a fire alarm control panel. The loop card 202 may also help identify each fire sensing device within a fire loop by its unique address for precise detection within an addressable fire alarm system.

Loop card 202 may power the fire sensing devices 208 in both directions such that the first half of the loop is driven in sequence from fire sensing device 208-1 to fire sensing device 208-2 and the second half of the loop is driven from fire sensing device 208-7 to fire sensing device 208-6.

In the example illustrated in FIG. 2, a fire loop extender module 208-3 is in communication with fire sensing devices 208-1, 208-2, 208-6, 208-7 of a first fire loop that may be powered by loop card 202. The fire loop extender module 208-3 may operate as a fire sensing device and an addressable device within a first loop managed by the loop card 202. For example, fire loop extender module 208-3 may have its own unique address for management under loop card 202.

The fire loop extender module 208-3 may also operate as a loop card and power fire sensing devices 208-3-1, 208-3-2, 208-3-4, 208-3-5 in an additional loop independently from the original loop. Fire sensing devices 208-3-1, …, 208-3-5 may operate under a sub-address of fire loop extender module 208-3 and may address from fire loop extender module 208-3. For example, fire loop extender module 208-3 may power fire sensing devices 208-3-1, …, 208-3-5 independently from the fire sensing devices of the first loop.

Further, fire loop extender module 208-3 may power fire sensing devices 208-1, 208-2, 208-6, and 208-7 when loop card 202 is experiencing a fault or failure event. Fire loop extender module 208-3 may be powered by an external power supply 210 that is separate from the control panel such that it can operate independently from loop card 202 and operation of fire sensing devices within the first loop can be maintained.

Fire loop extender module 208-3 may support an additional fire loop extender module 208-3-3 to extend the existing fire loop. For example, a first plurality of fire sensing devices (e.g., devices 208-1, 208-2, 208-6, 208-7) of a first loop may occupy a maximum point capacity of the control panel. Further, fire loop extender module 208-3 can have a large enough point capacity to support additional fire sensing devices (e.g., 208-3-1, …, 208-3-5) and fire loop extender module 208-3-3. Fire loop extender module 208-3-3 may operate under a sub-address of fire loop extender module 208-3 and address from fire loop extender module 208-3.

The additional fire loop extender module 208-3-3 may operate as a fire sensing device (e.g., alarm, smoke detector). Fire loop extender module 208-3-3 may be connected to an external power supply 210 to maintain operation during a fault or failure event. Fire loop extender module 208-3-3 may be configured to power and/or manage fire sensing devices 208-3-1, 208-3-2, 208-3-4, 208-3-5 in the event of fire loop extender module 208-3 experiencing a fault or failure event. Further, fire loop extender module may drive the loop in either direction (e.g., clockwise or counterclockwise) in the event that a fire sensing device within the second loop experiences a fault or failure event. For example, in the case of fire sensing device 208-3-2 experiencing a fault or failure event, fire loop extender module 208-3-3 may power the second loop beginning with fire sensing device 208-3-4 (e.g., clockwise).

As illustrated in FIG. 2, fire loop extender module 208-3-3 may drive the second loop in both directions such that a first half of the loop (e.g., fire sensing devices 208-3-2 and 208-3-1) are driven in parallel with a second half of the loop (e.g. fire sensing devices 208-3-4 and 208-3-5). Alternative configurations are possible and examples are not to be taken in a limiting sense.

Fire loop extender module 208-3-3 may be configured to operate and/or manage a third fire loop extending from the first and second fire loops. For example, as illustrated in FIG. 2, fire loop extender module 208-3-3 may power fire sensing devices 208-3-6 and 208-3-7 in a third fire loop. Fire sensing device 208-3-6 and fire sensing device 208-3-7 may operate under sub-addresses addressing from fire loop extender module 208-3. Fire loop extender module 208-3-3 may be configured to support additional fire sensing devices in the third fire loop, or additional fire loop extender modules.

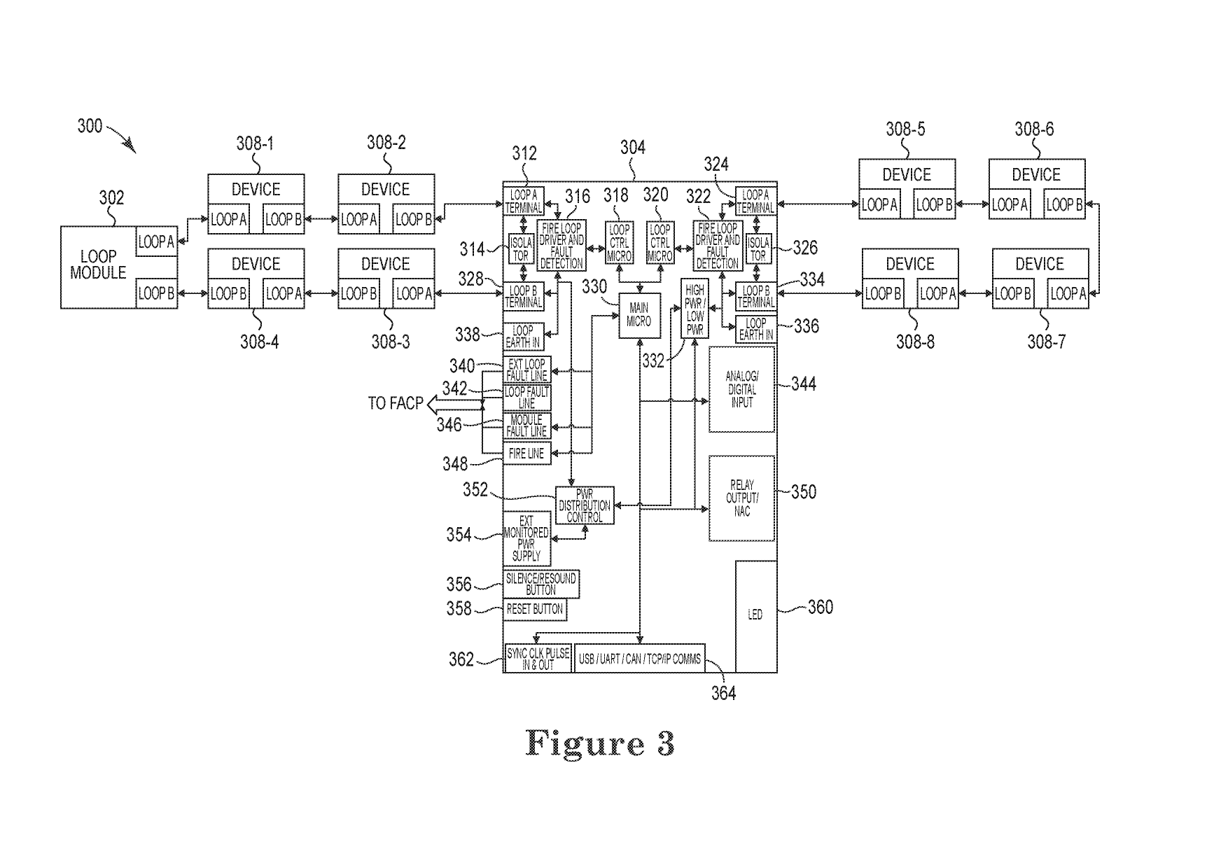

FIG. 3 illustrates an example of a system including a fire loop extender module in accordance with an embodiment of the present disclosure. Fire loop extender module 304 may be fire loop extender module 104 or fire loop extender module 208-3 as described in connection with FIGS. 1 and 2, respectively.

In the fire system 300 depicted in FIG. 3, a fire loop module 302 may be wired in a loop configuration with a plurality of fire sensing devices 308-1, 308-2, 308-3, 308-4, which may collectively be referred to as fire sensing devices 308. The loop module 302 may be a loop card, such as loop card 202 as described in connection with FIG. 2. Loop module 302 may be physically located within a fire alarm control panel of a fire system. The loop module 302 may be configured to operate and/or power fire sensing devices 308.

A fire loop extender module 304 may be wired in a loop configuration with loop module 302 and fire sensing devices 308. The loop extender module may operate in a similar manner to loop extender module 102 and loop extender module 208-3, as described in connection with FIGS. 1 and 2, respectively. For example, loop extender module 304 may function as a fire sensing device (e.g., fire detection), loop booster, or loop extension module.

As illustrated in FIG. 3, loop extender module 304 may be configured to function as a fire sensing device in sequence with fire sensing devices 308 within the loop configuration. For example, loop extender module 304 may be configured to operate in sequence with fire sensing devices 308-2 and 308-5 or fire sensing devices 308-8 and 308-3 when operating in a clockwise direction, and in a reverse order when operating in a counterclockwise direction.

The fire sensing devices 308 powered by loop module 302 may be configured to operate in either direction, for example, redundant operation. As illustrated in FIG. 3, each fire sensing device 308 can be configured to operate as “loop A” or “loop B” such that, in case of a fault or failure event of a fire sensing device within the fire loop, communication among the remaining fire sensing devices in the fire loop is not interrupted and normal operation may continue. For example, if fire sensing device 308-1 is experiencing a fault or failure event when the fire loop is in the “loop A" configuration (e.g., clockwise powered from loop module 302), then the fire loop may continue in the “loop B” configuration such that communication continues in a counterclockwise direction powered from loop module 302 and onto fire sensing device 308-4.

Fire loop extender module 304 can also provide redundant fire loop operation during panel loop failures (e.g., loop module 302 failures) that can perform fire loop detections, fire and fault reporting to the control panel, and local activation based on certain configurations. Fire loop extender module 304 can also leverage the capability of a loop booster to boost the loop signal on the extended loop section (e.g., fire sensing devices 308-5, 308-6, 308-7, 308-8), as well as limiting the current on the extended loop, which is suitable for Intrinsic Safe Environment and explosive atmosphere (e.g., ATEX) usages.

The loop extender module 304 may be configured to operate as a loop module (e.g., power and/or manage fire sensing devices 308) in the event of loop module 302 experiencing a fault or failure event. For example, loop extender module 304 may be configured with functionalities to maintain control and operation of fire sensing devices 308 such that the fire loop may continue operating without interruption. These functionalities are supported by a number of components as illustrated in FIG. 3.

The fire loop extender module 304 may be controlled by a main microcontroller 330 located within the loop extender module 304. Additional circuitry may be available for management of particular loops (e.g., original fire loop and extended fire loop) using loop control microcontroller 318 and 320.

Fire loop extender module 304 may be powered by an external power supply. The fire loop extender module may be configured to be powered by an external power supply through circuitry such as circuitry 354. Additional power distribution control circuitry 352 may be utilized to manage and allocate electrical power to various subsystems and components within the fire loop extender module 304. The power distribution control circuitry may be configured to switch between a primary power source and a backup power source (e.g., external power supply).

As an example, fire loop extender module 304 may be configured to power fire sensing devices in the “loop A” configuration or “loop B” configuration using loop A terminal connections 312 and 324 or loop B terminal connections 334 and 328. In this way, fire loop extender module 304 may be configured to provide redundant operation.

Further, fire loop extender module 304 may be configured to communicate with a first plurality of fire sensing devices (e.g., 308-1, 308-2, 308-3, 308-4) wired in a first loop via a first communication pathway. For example, the first communication pathway may include loop A terminal connection 312 and/or loop B terminal connection 328. The fire loop extender module 304 may be configured to communicate with a second plurality of fire sensing devices (e.g., 308-5, 308-6, 308-7, 308-8) wired in a second loop, wherein the second loop is independent of the first loop, via a second communication pathway. For example, the second communication pathway may include loop A terminal connection 324 and/or loop B terminal connection 334.

Fire loop extender module 304 may detect faults or failures within fire sensing devices 308 using fire loop driver and fault detection circuitry 316 or 322. For example, fire loop extender module 304 may detect when fire sensing device 308-7 is experiencing a fault or failure event using circuitry 322. The loop extender module 304 can detect open, short, and earth related problems on both sides of the loop using circuitry such as loop earth in 338, loop earth in 336, extended loop fault line 340, loop fault line 342, module fault line 346, and fire line 348. If the loop extender module 304 experiences failure, a module fault is triggered and can be detected on the other end of the digital line.

Fire loop extender module 304 can indicate a fire using the fire loop communications (e.g., 348) and digital fire signal such that these operations can be utilized externally. The communications can provide real time status updates of events occurring from the fire sensing devices 308 connected to the fire loop as well as the running status of the loop extender module 304 itself.

The loop extender module 304 can be configured in an ATEX environment such that controlled current can be pumped into the loop or zone input/output (e.g., I/O) 344 based on the configuration. The loop extender module 304 can also be configured for local mode operation during a fault such as when the loop module communication is interrupted. In such an instance, fire and fault signals can still be initiated by the loop extender module 304 based on the fire system devices within the loop or zone input, and provide local activation based on a defined output configuration or a default all out configuration.

Loop extender module 304 may include local activation cause and effect logic that can be programmed by a user based on a type of activation that may occur during a fault, fire, or loop module failure on the fire loop. If there are no cause and effect configurations set by a user, then a default configuration may be used by the loop extender module 304 to activate all the connected outputs. The loop extender module 304 may comprise light-emitting diodes (LEDs) 360 that can indicate detection of a fire from the extended loop devices (e.g., fire sensing devices 308-5, 308-6, 308-7, 308-8) and fire loop devices during operation in redundant mode (e.g., fire sensing devices 308-1, 308-2, 308-3, 308-4). Similarly, the LEDs 360 can indicate faults as well as normal operation of the fire loop extender module 304. The fire loop extender module 304 may comprise buttons for silence/sound 356 and reset operation 358 when the loop module 302 has failed, and the fire loop extender module 304 is operating in redundant mode controlling both the fire loop devices and the extended loop devices and zone devices.

Additional circuitry such as isolation circuitry 314, 326 may provide additional safety and reliability for fire loop extender module 304 by aiding in electrical fault detection (e.g., short circuits or overcurrent conditions) in the wiring of fire loop extender module 304 or connected devices (e.g., fire sensing devices 308). Isolators 314, 326 may isolate the affected segment of the circuit when a fault is detected.

Synchronization signals can be used to coordinate the operation of multiple devices within fire system 300 such that, for example, fire loop extender module 304 and fire sensing device 308-1 operate in a synchronized manner. A clock pulse (e.g., such as sync clk pulse in & out 362) may be used as a timing signal to help ensure these devices are working synchronously.

Additional interfaces may be utilized for data exchange, device control, and integration with other devices or systems. For example, universal serial bus (USB), universal asynchronous receiver-transmitter (UART), controller area network (CAN), transmission control protocol (TCP) and internet protocol (IP) communications component 364 can be utilized for integration of the fire loop extender module 304 within a fire system.

Circuitry such as relay output/notification appliance circuits (NAC) 350 may aid in the management of fire detection response and trigger various external devices when needed. For example, the fire loop extender module 304 may use relay output/NAC 350 to activate external systems such as sprinklers, elevator shutdowns, or HVAC shutdowns to prevent the spread of smoke during a fire event.

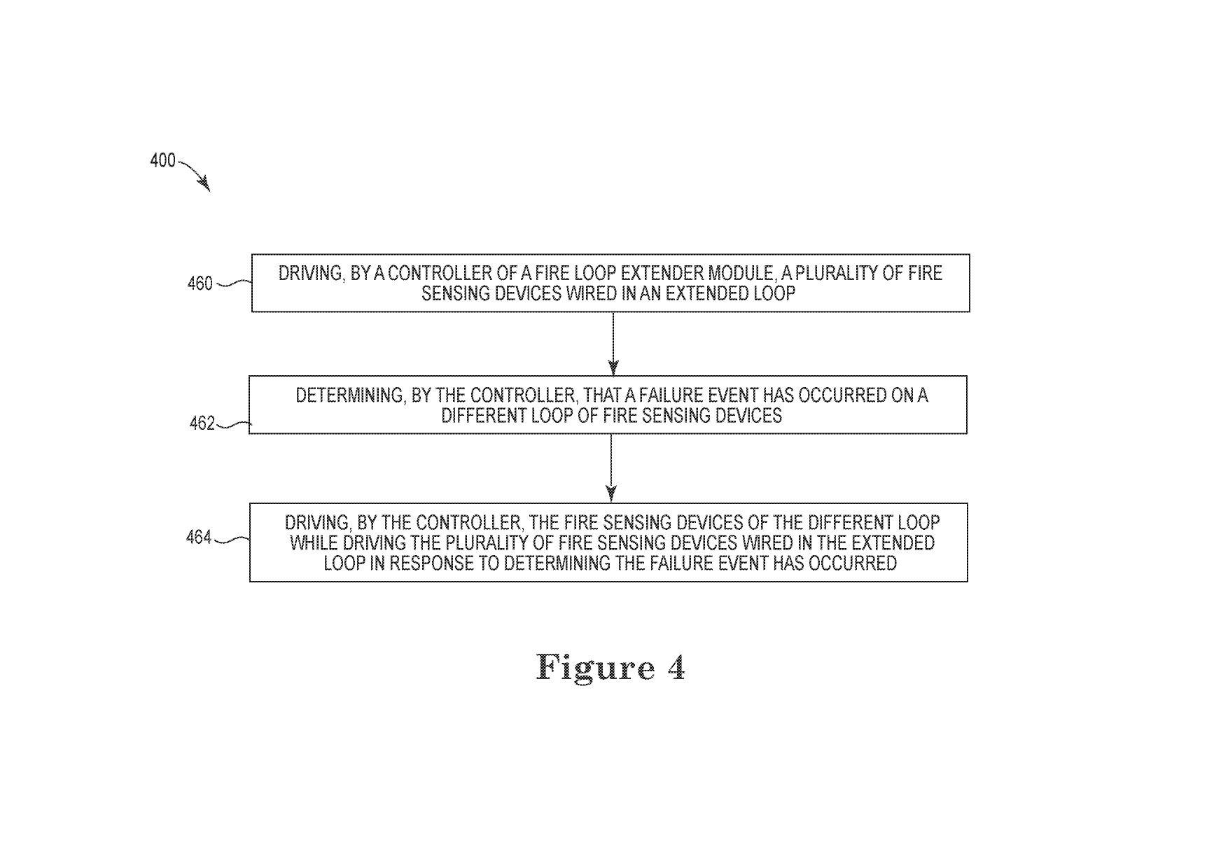

FIG. 4 illustrates a flow diagram of a method for extending a fire loop in accordance with an embodiment of the present disclosure. Although the method 400 is illustrated in a particular sequence, embodiments are not limited as such, and operations can be performed in varying order unless stated otherwise. Some or all portions of method 400 may be performed by the fire loop extender module described in connection with FIG. 3, for example.

At block 460, the method includes driving, by a controller of a fire loop extender module, a plurality of fire sensing devices wired in an extended loop. For example, fire loop extender module 304 of FIG. 3 may drive fire sensing devices 308-5, 308-6, 308-7, 308-8 by controller 330.

At block 462, the method includes determining, by the controller, that a failure event has occurred on a different loop of fire sensing devices. For example, controller 330 of fire loop extender module 304 in FIG. 3 may determine that a failure event has occurred in the fire loop connecting fire sensing devices 308-1, 308-2, 308-3, and 308-4.

At block 464, the method includes driving, by the controller, the fire sensing devices of the different loop while driving the plurality of fire sensing devices wired in the extended loop in response to determining the failure event has occurred. For example, fire loop extender module 304 may drive the fire sensing devices 308 of the original loop and the extended loop in parallel. The fire loop extender module 304 may be configured to drive fire sensing devices in the original fire loop (e.g., devices 308-1, …, 308-4) only during a failure event of the loop module 302. For example, the loop module 302 may be configured to drive a first plurality of fire sensing devices (e.g., devices 308-1, …, 308-4) of a first loop (e.g., the original loop) during normal operation of the control panel. Further, fire loop extender module 304 may be configured to drive fire sensing devices in an extended loop (e.g., 308-5, …, 308-8) during normal operation. When a failure event has been detected in the original loop, the fire loop extender module 304 can control operation of the fire sensing devices within the original loop in additional to the fire sensing devices of the extended loop.

The method 400 can include reporting, by the controller, that the failure event has occurred to a control panel of a fire alarm system. For example, fire loop extender module 304 of FIG. 3 may report that a failure event has occurred to the fire alarm control panel via a direct communication pathway using circuitry 340, 342, 346, 348.

The method 400 can include receiving, from one of the plurality of fire sensing devices, an indication that a fire event is occurring and providing, via a physical indicator of the fire loop extender module, an indication (e.g., a visual and/or audio indication) of the fire event in response to receiving the indication that the fire event is occurring. For example, the fire loop extender module 304 can indicate that a fire event is occurring via LED 360.

Driving the plurality of fire sensing devices wired in the extended loop may include operating in a local activation mode and driving the fire sensing devices of the different loop may include operating in a redundant mode. For example, when the fire loop extender module 304 is operating fire sensing devices 308-1, …, 308-4, the fire loop extender module 304 may be operating in a redundant mode in the event of a fault or failure.

The method 400 may also include driving, by a controller of an additional fire loop extender module wired in the extended loop, an additional plurality of fire sensing devices wired in an additional extended loop. For example, as illustrated in FIG. 2, fire loop extender module 208-3-3 may drive fire sensing device 208-3-6 and fire sensing device 208-3-7.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A device for a fire alarm system, comprising:
a first communication pathway coupled to a first plurality of fire sensing devices wired in a first loop;
a second communication pathway coupled to a second plurality of fire sensing devices wired in a second loop, wherein the second loop is independent of the first loop; and
a controller configured to:
drive the second plurality of fire sensing devices of the second loop; and
drive the first plurality of fire sensing devices of the first loop during a failure event occurring on the first loop.

2. The device of claim 1, wherein the controller is configured to drive the second plurality of devices of the second loop while driving the first plurality of devices of the first loop during the failure event.

3. The device of claim 1, further comprising circuitry configured to:
detect the failure event occurring on the first loop; and
report the detected failure event to a control panel of the fire alarm system.

4. The device of claim 1, wherein the controller is further configured to drive the first plurality of fire sensing devices of the first loop and the second plurality of fire sensing devices of the second loop using different protocols.

5. The device of claim 1, wherein the device is directly connected to a control panel of the fire alarm system via a third communication pathway.

6. The device of claim 1, further comprising indicators configured to provide a visual and audio indication of the failure event.

7. The device of claim 1, wherein the device is powered by an external power supply.

8. A fire alarm system, comprising:
a control panel;
a first plurality of fire sensing devices wired in a first loop and in communication with the control panel; and
a fire loop extender module in communication with the control panel, the first plurality of fire sensing devices wired in the first loop, and a second plurality of fire sensing devices wired in a second loop, wherein:
the second loop is independent of the first loop;
the fire loop extender module is configured to drive the first plurality of fire sensing devices wired in the first loop during a failure of the control panel; and
the fire loop extender module is configured to drive the second plurality of fire sensing devices wired in the second loop.

9. The fire alarm system of claim 8, further comprising a fire loop module configured to drive the first plurality of fire sensing devices of the first loop during normal operation of the control panel.

10. The fire alarm system of claim 8, wherein the fire loop extender module is powered by an external power supply that is separate from the control panel.

11. The fire alarm system of claim 8, wherein the second plurality of fire sensing devices of the second loop are within a same address range as the first plurality of fire sensing devices of the first loop.

12. The fire alarm system of claim 8, wherein the second plurality of fire sensing devices of the second loop are in an address range that is separate from an address range of the first plurality of fire sensing devices of the first loop.

13. The fire alarm system of claim 8, wherein the second plurality of fire sensing devices of the second loop are in communication with the fire loop extender module via a plurality of channels addressed from the fire loop extender module.

14. The fire alarm system of claim 8, wherein the first plurality of fire sensing devices of the first loop are of a different type of fire sensing device than the second plurality of fire sensing devices of the second loop.

15. The fire alarm system of claim 8, wherein the first plurality of fire sensing devices of the first loop occupy a maximum point capacity of the control panel.

16. A method, comprising:
driving, by a controller of a fire loop extender module, a plurality of fire sensing devices wired in an extended loop;
determining, by the controller, that a failure event has occurred on a different loop of fire sensing devices; and
driving, by the controller, the fire sensing devices of the different loop while driving the plurality of fire sensing devices wired in the extended loop in response to determining the failure event has occurred.

17. The method of claim 16, further comprising reporting, by the controller, that the failure event has occurred to a control panel of a fire alarm system.

18. The method of claim 16, further comprising:
receiving, from one of the plurality of fire sensing devices, an indication that a fire event is occurring; and
providing, via a physical indicator of the fire loop extender module, an indication of the fire event in response to receiving the indication that the fire event is occurring.

19. The method of claim 16, wherein:
driving the plurality of fire sensing devices wired in the extended loop includes operating in a local activation mode; and
driving the fire sensing devices of the different loop includes operating in a redundant mode.

20. The method of claim 16, further comprising driving, by a controller of an additional fire loop extender module wired in the extended loop, an additional plurality of fire sensing devices wired in an additional extended loop.
